(19) United States
(12) Patent Application Publication
(10) Pub. No.: US 2008/0301789 A1
(43) Pub. Date: Dec. 4, 2008

(54) METHOD AND SYSTEM FOR REAL WORLD VERIFICATION OF A PERSON AND/OR BUSINESS IDENTITY AT A CENTRAL LOCATION FOR REAL AND VIRTUAL WORLD

(76) Inventor: Frederick D. Foster, Philadelphia, PA (US)

Correspondence Address: Diane Dunn McKay, Esq.;Mathews, Shepherd, McKay & Bruneau, P.A., Suite 201, 29 Thanet Road, Princeton, NJ, 08540, US

(21) Appl. No.: 12/129,755

(22) Filed: May 30, 2008

Related U.S. Application Data
(60) Provisional application No. 60/932,276, filed on May 30, 2007.

(51) Int. Cl. H04L 9/32

(52) U.S. Cl. 726/6

(57) ABSTRACT

The method and system of the present invention provides a central location, such as the United States Postal Service® (USPS), a product that will advance them into the world of internet business and will in turn offer the opportunity for new sources of revenue. The method and system of the present invention has the facilities to verify a person's and/or businesses identity. The verification process can be done in the same manner as money order, check cashing and real P.O. boxes, which are currently limited to availability in the post office. If the user is verified at the central location, the user's e-mail address, domains, ISP, WSP, and Web Sites can be globally registered at one or more e-mail servers or service providers that participate with the verification. The e-mail server or service providers can attach a symbol of the identity verification on all e-mail sent by the e-mail server or service provider from the verified customer.

### CROSS REFERENCE TO RELATED APPLICATION

This application claims the benefit of U.S. Provisional Patent Application No. 60/932,276 filed May 30, 2007 the entirety of each of which is hereby incorporated by reference into this application.

### BACKGROUND OF THE INVENTION

1. Field of the Invention

The present invention relates to a method and system for verification of a person and/or business identity at a central location allowing global registration of electronic mail addresses, domains, ISP, WSP, websites of the verified person and/or business identity at one or more e-mail servers and/or service providers.

2. Description of Related Art

Due to modern technology, most mailing is done via e-mail. Many Internet users prefer e-mail for sending and receiving private mail or even invoices and bills. It is simply a faster way of mailing and the service is normally free. Users often sign up with the services of Yahoo!®, Hotmail, Gmail™ or their own ISP to acquire an e-mail address. Other users setup their e-mail addresses through their domains or WSP. All these service providers have one thing in common. They cannot verify the identity of the person signing up. Because of this inability, individuals with fraudulent intent can easily set up fake businesses on the Internet. With sixty percent (60%) of the worlds reported Internet fraud perpetrators operating from the United States, foreign consumers can be reluctant to make purchases from our businesses. Internationally, the United States is often viewed as a high risk area when it comes to Internet transactions. Basically, all businesses, whether large or small, legitimate or fraudulent, do some interaction via the Internet.

According to the annual iC3 Report (by the NW3C and the FBI) from December 2006, fraudulent activity is an increasing concern for the business and private interactions done via the Internet. The problems arising are business related and are non-delivery of goods, identity theft, fraudulent invoices, non-paying customers, as well as predators and online stalking on the private level. The iC3 Report attempts to show how consumers and businesses can protect themselves against these activities, but does not offer concrete solutions to prevent fraud.

It is desirable to provide a method and system for verification of a person and/or business identity at a central location.

### SUMMARY OF THE INVENTION

The method and system of the present invention provides a central location, such as the United States Postal Service® (USPS), a product that will advance them into the world of internet business and will in turn offer the opportunity for new sources of revenue. The method and system of the present invention has the facilities to verify a person's and/or businesses identity. The verification process can be done in the same manner as passports and real P.O. boxes, check, and money order cashing which are currently limited to availability in the post office. If the user is verified at the central location, the user's e-mail addresses, domains, ISP, WSP and websites can be globally registered at one or more e-mail servers or service providers that participate with the verification. The e-mail server or service providers can attach a symbol of the identity verification on all e-mail sent by the e-mail server or service provider from the verified customer. The protocols by which the method and system of the present invention is governed will immediately and effectively deter potential fraud.

The method of the present invention is beneficial to all businesses, especially new businesses, since the logo will serve as a certification while they build a reputation. Instead of just using a P.O. box or a physical address in the contact section of their website, the business can offer the verification of their business by showing a link, logo, and e-mail address of a virtual e-mail box. The consumer can know right away, that this person, business or the business owner has been verified through the method and system of the present invention.

Companies, such as eBay®, MySpace, Amazon and others, can ease their process of identifying users, if they use the method and system of the present invention and make it a requirement for merchants. The method and system of the present invention builds trust towards the consumer and protects businesses as well.

The present invention has the ability to prevent fraudulent activities and predators from joining free spaces, such as MySpace and eBay®, because now they can be tracked down by the central location.

Online businesses can have the ability to send their advertisement through the online services of the method and system of the present invention. Accordingly, the identity of the recipient in this case will not be given to the advertiser allowing the recipient to enjoy full privacy along with the confidence that the e-mail is from a legitimate source.

The system of the present invention provides a secure mailing center for both real and online businesses, as well as private users. It can be an effective way to decrease the online crime rate through the verification of the central location.

The invention will be more fully described by reference to the following drawings.

### BRIEF DESCRIPTION OF THE DRAWINGS

FIG. 1 is a flow diagram of a method for verification of a person and/or business identity at a central location of the present invention.

FIG. 2 is a schematic diagram of a system for verification of a person and/or business identity at a central location.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

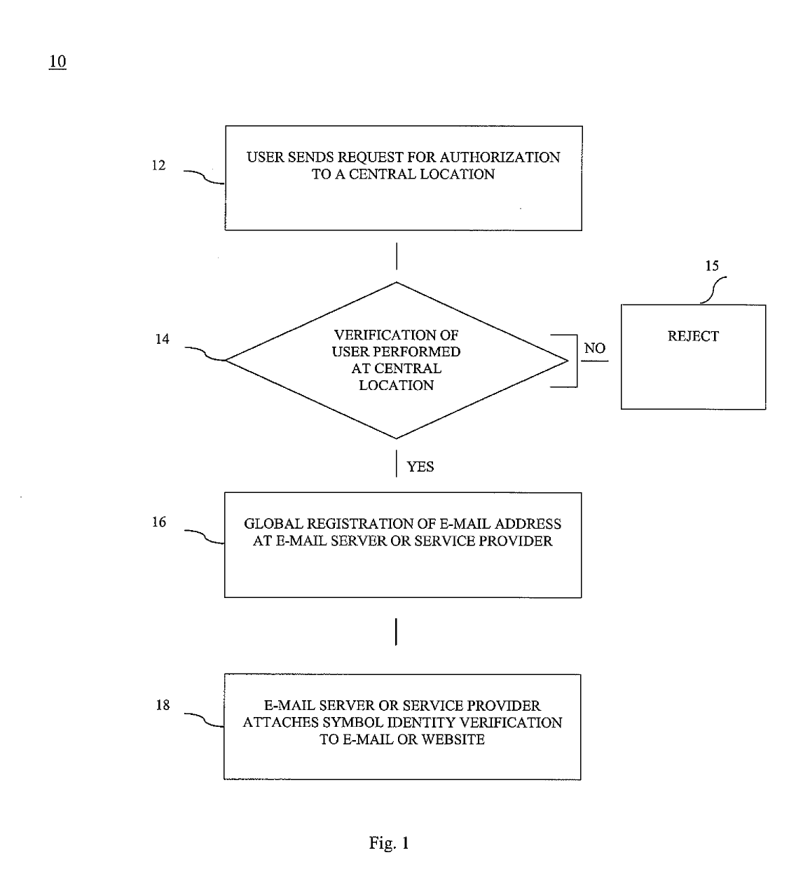

FIG. 1 is a flow diagram of a method for verification of a person and/or business identity at a central location. In block 12, a user sends a request for authorization to a central location. For example, the request can be performed by completing an application on a website of a central location or in person at the central location.

In block 14, upon receiving the application, a verification of the user is performed at the central location. In one embodiment, the user physically presents information in person at the central location of the identity of the person or a business entity. Alternatively, the user can forward the information to the central location. The user can present one or more types of evidence, such as a driver's license, passport, birth certificate, marriage license, utility bill, certificate of incorporation, and the like, at the central location. In one embodiment, the central location is the United States Postal Service® (USPS). In this embodiment, the user can be verified in the same manner as money order bearers are currently verified. Alternatively, the central location can be the state division of motor vehicles or alternate government agencies, check cashing and money transferring agencies, Western Unions, Money Grams.

If the user is not verified, the user is rejected in block 15. If the user is verified at the central location, the user's e-mail addresses, domains, ISP, WSP, and web site can be globally registered at one or more e-mail servers or service providers that participate with the verification at the central location in block 16. For example, service providers, such as eBay®, MySpace and Amazon can use the verification at the central location to provide an identification of integrity of its customers.

In block 18, the e-mail server or service providers can attach a symbol of the identity verification on all e-mail sent by the server or service provider from the verified customer. For example, the symbol can be a logo or a link. Alternatively, the service provider can attach a symbol of the identity verification for all website hosting or transactions performed by the service provider.

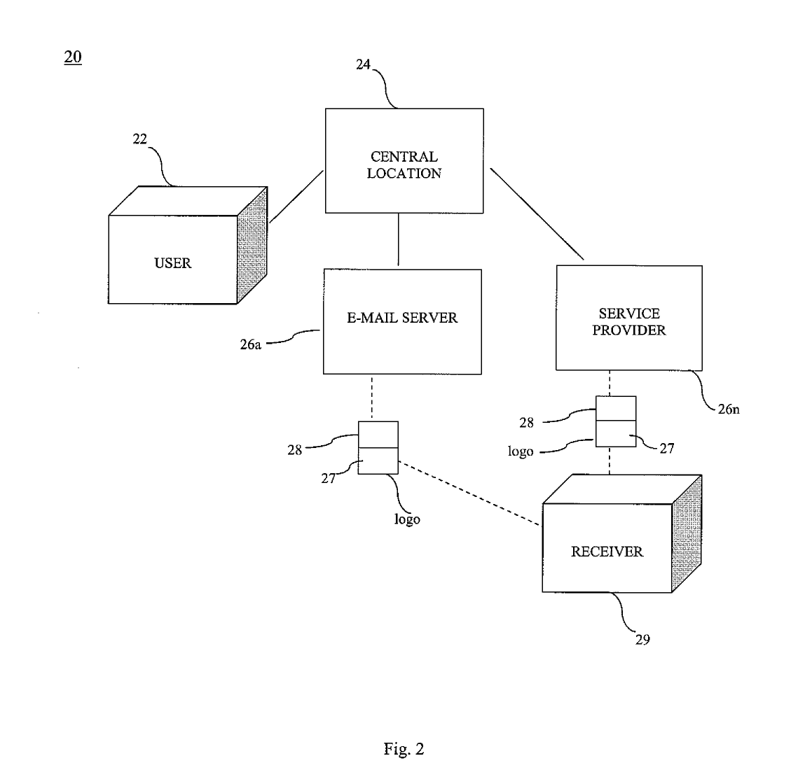

FIG. 2 is a schematic diagram of a system for verification of a person and/or business identity at a central location 20. User 22 submits an application to central location 24. User 22 or a business entity is verified at central location 24 by presenting requested evidence of identity, as described above. One or more e-mail servers or service providers 26a-26n receive global authorization of the user from central location 24. E-mail server or service providers 26a-26n attach a symbol 77, such as a link or logo, to each e-mail or transaction 28 which are received at receiver 29. Accordingly, receiver 29, upon review of the link, logo or symbol is aware that the e-mail or transmission was initiated by a verified user. For example, the central location, such as the USPS can make an arrangement with MySpace. If a new member signs up with the e-mail address of which has been verified at the central location, this member can automatically receive a symbol of identity verification from the service provider. Younger members, as well as adults, can now see that this person is not an imaginary friend anymore, but a real life person. Should this member be a predator or online stalker, the authorities have the chance of tracking the person down.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for verification of an identity comprising the steps of:
(a) requesting authorization at a central location;
(b) verifying information of identity after receiving the request for authorization, said information of identity being received at said central location; and
(c) globally registering an e-mail address associated with said identity verified in step (b) at one or more e-mail servers or service providers.

2. The method of claim 1 further comprising the step of:
attaching a symbol of identity verification to an e-mail generated at said one or more e-mail servers of the globally registered e-mail address.

3. The method of claim 1 further comprising the step of:
attaching a symbol of identity verification to a website hosted by said one or more service providers.

4. The method of claim 1 wherein in step (b) the information of identity is physically presented at said central location.

5. The method of claim 1 wherein the central location is a government agency.

6. The method of claim 1 wherein the central location is the United States Postal Service®.

7. A system for verification of an identity comprising:
means for requesting authorization at a central location;
means for verifying information of identity after receiving the request for authorization of said information of identity being received at said central location; and
means for globally registering an e-mail address associated with the verified identity at one or more e-mail servers or service providers.

8. The system of claim 7 further comprising:
means for attaching a symbol of identity verification to an e-mail generated at said one or more e-mail servers of the globally registered e-mail address.

9. The system of claim 7 further comprising:
means for attaching a symbol of identity verification to a website hosted by said one or more service providers.

10. The system of claim 7 wherein the information of identity is physically presented at said central location.

11. The system of claim 7 wherein the central location is a government agency.

12. The system of claim 7 wherein the central location is the United States Postal Service®.
